(19) United States
(12) Patent Application Publication
(10) Pub. No.: US 2026/0186130 A1
(43) Pub. Date: Jul. 2, 2026

(54) AUGMENTING OF RADAR DATA USING VISION AND CONSTRUCTION TECHNIQUES

(71) Applicant: TOYOTA MOTOR ENGINEERING & MANUFACTURING NORTH AMERICA, INC., PLANO, TX (US)

(72) Inventors: AKILA C. GANLATH, San Jose, CA (US); AHMADREZA MORADIPARI, Mountain View, CA (US); SERGEI S. AVEDISOV, Mountain View, CA (US); QI CHEN, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 19/005,954

(22) Filed: Dec. 30, 2024

(51) Int. Cl. G01S 13/931; B60W 30/09; G01S 13/86; G06T 17/05; G06V 20/56

(52) U.S. Cl. CPC G01S 13/931; B60W 30/09; G01S 13/867; G06T 17/05; G06V 20/56; B60W 2754/10

(57) ABSTRACT

A system includes first sensor systems that obtain first obstacle data of an obstacle within a threshold distance of an ego vehicle and second sensor systems that obtain second obstacle data of the obstacle. The first sensor systems include a radar. The second sensor systems include a camera. The system includes one or more processors, and a memory storing instructions that, when executed by the one or more processors, cause the system to perform operations. The operations include determining, based on the first obstacle data, a first representation of the obstacle, applying one or more construction techniques to the second obstacle data to obtain a second representation of the obstacle, aligning the second representation with the first representation, and augmenting the first representation with the aligned second representation to generate an augmented representation of the obstacle.

### TECHNICAL FIELD

The present disclosure relates generally to augmenting sensor data due to certain sensor limitations. Some aspects of the disclosure relate to augmenting radar data during navigation of a vehicle.

### DESCRIPTION OF RELATED ART

Different sensor technologies associated with a vehicle may have advantages and drawbacks. For example, radar technologies may have advantages including sufficient performance during inclement weather conditions such as fog, rain, or snow, an ability to detect objects around corners, and ability to measure a speed of an object using Doppler effect. However, at least some radar technologies may have drawbacks such as limited beam steering capabilities which results in a narrow beam focus. In particular, some radar technologies are unable to capture a comprehensive field of view because of a limited field of scan of the radar. In some instances, a field of scan of the radar is limited to a relatively horizontal area. These radar technologies may have limited capability of scanning vertically, which constraints the ability of the radar to capture an accurate three-dimensional (3-D) representation of an object.

### BRIEF SUMMARY OF THE DISCLOSURE

According to various embodiments of the disclosed technology, a system associated with a vehicle (e.g., an ego vehicle) comprises one or more one or more first sensor systems configured to obtain first obstacle data of an obstacle within a threshold distance of an ego vehicle and one or more second sensor systems configured to obtain second obstacle data of the obstacle. The one or more first sensor systems comprise a radar sensor. The one or more second sensor systems comprise a camera. The system comprises one or more processors. The system comprises a memory storing instructions that, when executed by the one or more processors, cause the system to perform operations. The operations include determining or generating, based on the first obstacle data, a first representation of the obstacle; selectively applying one or more construction techniques to the second obstacle data to obtain or generate a second representation of the obstacle; aligning the second representation with the first representation; and augmenting the first representation with the aligned second representation to generate an augmented representation of the obstacle.

In some embodiments, the selectively applying one or more construction techniques to the second obstacle data to generate a second representation of the obstacle may refer to applying one or more construction techniques when a second representation of the obstacle, which has 3-D characteristics of the obstacle, is unavailable, otherwise insufficient, or has not been learned or made cognizant of by the system. If the second representation is available and/or sufficient and/or has been learned by the system, then the second representation does not need to be generated, and may be stopped or prevented from being generated.

In some embodiments, the second representation of the obstacle comprises a three-dimensional (3-D) representation, the second obstacle data comprises two-dimensional (2-D) data, and the applying one or more construction techniques to the second obstacle data comprises transforming the 2-D data into the 3-D representation.

In some embodiments, the selectively applying one or more construction techniques to the second obstacle data is performed in response to one or more trigger conditions.

In some embodiments, the one or more trigger conditions comprise a navigation action of the ego vehicle or a deviation between a pose estimate and the second representation. In some embodiments, the pose estimate is based on the second obstacle data.

In some embodiments, the instructions, which when executed by the one or more processors, further cause the processor to perform: based on the augmenting representation, determining a resolved distance between the ego vehicle and the obstacle, wherein the resolved distance is different from a distance between the ego vehicle and the obstacle estimated based on the first representation; and performing a navigation action on the ego vehicle based on the resolved distance.

In some embodiments, the navigation action on the ego vehicle comprises setting or changing a relative distance between the ego vehicle and the obstacle.

In some embodiments, the instructions that, when executed by the one or more processors, further cause the system to perform: determining whether the second representation of the obstacle is known, wherein the applying one or more construction techniques is in response to determining that a second representation of the obstacle is unknown, unavailable, insufficient, or unlearned.

In some embodiments, the instructions that, when executed by the one or more processors, further cause the system to perform: in response to determining that the second representation of the obstacle is known and/or sufficient, terminating the applying one or more construction techniques or otherwise preventing the occurrence of applying one or more construction techniques.

In some embodiments, the one or more construction techniques comprise a Neural Radiance Field (NeRF), a Gaussian Splatting, or a view synthesis technique, and/or related techniques.

In some embodiments, the aligning the second representation with the first representation is based on a translation, a rotation, or a scaling operation applied to the second representation based on a translation, a rotation, or a scaling offset between the first representation and the second representation. In some embodiments, the aligning the second representation with the first representation is based on a shape registration algorithm and/or an aligning algorithm, such as an iterative closest point (ICP) algorithm or a similar algorithm.

In some embodiments, the vehicle system comprises a database system, and at least some of the aforementioned operations are performed remotely from the vehicle system. For example, at least some of the aforementioned operations may be performed by a different database system and/or an external system such as a cloud or edge computing system. The vehicle system may obtain one or more results of the aforementioned operations via communication with the different database system and/or the external system.

According to various embodiments of the disclosed technology, a vehicle control system comprises a processor and a memory coupled to the processor to store instructions, which when executed by the processor, cause the processor to perform operations. The operations comprise obtaining, from one or more first sensor systems, first obstacle data of an obstacle within a threshold distance of an ego vehicle; determining or generating, based on the first obstacle data, a first representation of the obstacle; obtaining, from one or more second sensor systems, second obstacle data of the obstacle; applying one or more construction techniques to the second obstacle data to obtain or generate a second representation of the obstacle; aligning the second representation with the first representation; and augmenting the first representation with the aligned second representation to generate an augmented representation of the obstacle.

Previous features described with respect to the vehicle system may also be applicable to the vehicle control system.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example of an all-wheel drive hybrid vehicle with which embodiments of the systems and methods disclosed herein may be implemented.

FIG. 3 illustrates an example architecture for augmenting a first representation of an obstacle, generated or obtained from one or more first sensor systems, with a second representation of the obstacle, in accordance with one embodiment of the systems and methods described herein.

FIG. 4 illustrates an example implementation of constructing a three-dimensional (3-D) representation of an obstacle from one or more two-dimensional (2-D) images, in accordance with one embodiment of the systems and methods described herein. The 3-D representation may be a second representation of the obstacle and used to augment the first representation of the obstacle.

FIGS. 5A-5B illustrate scenarios of practical applications resulting from the augmentation, such as within an adaptive cruise control (ACC) context.

FIG. 6 is an example computing component that may be used to implement various features of embodiments described in the present disclosure.

The figures are not exhaustive and do not limit the present disclosure to the precise form disclosed.

### DETAILED DESCRIPTION

To address potential limitations associated with certain vehicle sensor technologies, a computing system of a vehicle (e.g., an ego vehicle) may augment first obstacle data of an obstacle captured by one or more first sensors or first sensor systems (hereinafter “first sensor systems”) of the ego vehicle. Sensor systems may include one or more sensors and/or any associated processing components (e.g., software, hardware, and/or firmware) to process raw sensor data captured by the sensors. In some embodiments, the one or more first sensor systems may include radar sensors. Potential limitations of radar may include limited beam steering capabilities which may result in insufficient rendering of three-dimensional (3-D) characteristics. This may result in inaccurate characterization of obstacles, and inaccurate distance detections between obstacles and/or between the ego vehicle and the obstacle. The inaccuracies may be magnified for obstacles with more complex and/or changing 3-D geometries.

In some embodiments, the computing system, or the first sensor systems, may further process raw sensor data captured by the radar sensors to generate one or more first representations. The processing may include filtering, converting (e.g., analog to digital conversion or vice versa), amplifying, smoothing, compressing, and/or otherwise synchronizing the raw sensor data.

The computing system may selectively augment the one or more first representations to amplify relevant 3-D characteristics of the first obstacle data. In some embodiments, the computing system may obtain second obstacle data of the obstacle. The second obstacle data may be captured by one or more second sensors or second sensor systems. In some examples, the one or more second sensors or second sensor systems may include one or more vision sensors such as cameras, which may have a wider field of view in certain directions compared to radar. The computing system may selectively construct, obtain, or generate (hereinafter “generate”) one or more second representations, which may include one or more 3-D representations, from the second obstacle data captured by the cameras. In some examples, the generating of the one or more second representations may utilize techniques to transform a series of 2-D images or frames into 3-D representations. The computing system may align the one or more second representations with the one or more first representations. For example, aligning may include determining translation, rotation, and/or scaling differences between the second representations and the first representations. The computing system may perform a transformation, such as a rigid transformation and/or a scaling operation, on the one or more second representations to align with the one or more first representations. Following alignment, the computing system may augment the one or more first representations with the one or more second representations. In some embodiments, augmenting may encompass fusing, merging, overlaying, synchronizing, smoothing, and/or otherwise combining certain features of the second representation onto the first representation.

As a result of augmenting the one or more first representations with the one or more second representations, the computing system addresses possible limitations associated with radar technology in certain contexts, while harnessing the advantages of radar technology. The computing system utilizes second sensor systems including cameras, in conjunction with construction techniques, in order to selectively generate a second representation, which may include a 3-D representation. Meanwhile, the techniques described herein also conserve computing resources and/or other onboard resources of a vehicle. First, only relevant 3-D features of the obstacle within the second representation may be used to augment the first representation. Certain redundant features from the second representation, which are already present in the first representation, may not need to be merged. Second, a 3-D representation of the obstacle may not need to be constantly generated. In some embodiments, if a 3-D representation of the obstacle is already available (e.g., stored and/or previously generated, and the obstacle has not changed its 3-D geometry) and/or has been learned or made cognizant of by the computing system, then the generating of the second representations may be terminated, skipped, avoided, or otherwise not commenced. Thus, the second representations may not be continuously fused with the first representation.

The computing system improves reliability of sensor data used for navigation purposes, which improves safety, efficiency, and reliability of a vehicle computing system. The computing system accurately detects and/or resolves the relevant 3-D characteristics of an obstacle even if radar technologies may have limited capabilities to detect and/or resolve such 3-D characteristics. This is especially important for obstacles that have complex and/or changing 3-D geometries. The technologies described herein thus provide technical benefits which amount to improvements in computer technology pertaining to vehicle navigation.

The technologies described herein may be applicable in certain contexts, scenarios, or applications (hereinafter “contexts”). Specific contexts in which the augmenting component may be applied include certain navigation functionalities such as Advanced Driver Assistance Systems (ADAS). More specifically, within ADAS, augmenting of radar data may provide more reliable sensor data as inputs for applications such as adaptive cruise control (ACC), blind spot detection, lane departure warning, and automatic emergency braking.

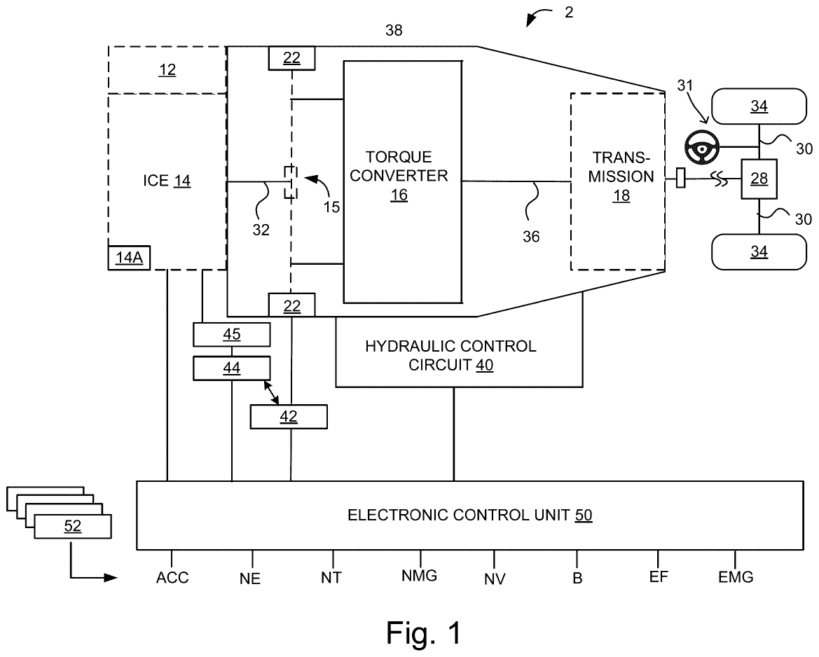

The systems and methods disclosed herein may be implemented with any of a number of different ego vehicles and ego vehicle types. For example, the systems and methods disclosed herein may be used with automobiles, trucks, motorcycles, recreational vehicles and other like on-or off-road vehicles. In addition, the principles disclosed herein may also extend to other vehicle types as well. An example hybrid electric vehicle (HEV) in which embodiments of the disclosed technology may be implemented as an ego vehicle and is illustrated in FIG. 1. Although the example described with reference to FIG. 1 is a hybrid type of ego vehicle, the systems and methods for driver fitness assessment can be implemented in other types of ego vehicles including gasoline-or diesel-powered vehicles, fuel-cell vehicles, electric vehicles, or other vehicles.

FIG. 1 illustrates a drive system of an ego vehicle 2 that may include an internal combustion engine 14 and one or more motors 22 (e.g., electric motors, which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30. The ego vehicle 2 may include a steering system 31. The steering system 31 may be implemented via electronic power steering (EPS) or steer-by-wire.

As an HEV, ego vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, ego vehicle 2 relies on the motive force generated at least by internal combustion engine 14, and a clutch 15 may be included to engage engine 14. In the EV travel mode, ego vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in ego vehicle 2 and is powered electrically via a battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and braking. As a more particular example, output torque of the motor 22 can be increased or decreased by electronic control unit 50 through the inverter 42. In some embodiments, the electronic control unit 50 may control the steering system 31.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit 40. When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, ego vehicle 2 may include an electronic control unit 50. Electronic control unit 50 may include circuitry to control various aspects of the vehicle operation. Electronic control unit 50 may include, for example, a microcomputer that includes one or more processing units (e.g., microprocessors), memory storage (e.g., RAM, ROM, etc.), and I/O devices. The processing units of electronic control unit 50 execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in ego vehicle 2. For example, electronic control unit 50 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 14 (engine RPM), a rotational speed, NMG, of the motor 22 (motor rotational speed), and vehicle speed, NV. These may also include torque converter 16 output, NT (e.g., output amps indicative of motor output), brake operation amount/pressure, B, battery SOC (i.e., the charged amount for battery 44 detected by an SOC sensor). Accordingly, ego vehicle 2 can include a plurality of sensors 52 that can be used to detect various conditions internal or external to the vehicle and provide sensed conditions to electronic control unit 50 (which, again, may be implemented as one or a plurality of individual control circuits). In one embodiment, sensors 52 may be included to detect one or more conditions directly or indirectly such as, for example, fuel efficiency, EF, motor efficiency, EMG, hybrid (internal combustion engine 14+cooling system 12) efficiency, acceleration, ACC, etc. In some embodiments, sensors 52 may detect navigation characteristics of the ego vehicle 2. Here, navigation characteristics may include an absolute position, an absolute velocity, an absolute heading, or an absolute acceleration of the ego vehicle 2 or of the obstacle.

In some embodiments, one or more of the sensors 52 may include, or be part of, sensor systems which include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

As evident, sensors 52 may be included to detect not only vehicle conditions but also to detect external conditions, such as of other obstacles, as well. Sensors that might be used to detect external conditions can include, for example, sonar, radar, lidar or other vehicle proximity sensors, and cameras or other image sensors. Thus, in some embodiments, the sensors 52 or a portion or subset thereof may be implemented as, or part of, the aforementioned first sensors, first sensor systems, second sensors, and/or second sensor systems. Image sensors can be used to detect, for example, objects such as traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The sensors 52 may be within an interior of a cabin of, or on an exterior of the ego vehicle 2. The sensors 52 may include impairment detecting sensors, such as in-cabin cameras, eye tracking sensors, and steering wheel monitoring systems. In particular, in-cabin cameras may include infrared cameras that monitor an occupant's eyes, face, and/or head to assess a measure of eye, facial, or head movements and/or a degree of stability or eye, facial, or head movements.

The sensors 52 may also include capturing sensors, which capture sensor data within the ego vehicle 2 or within surroundings of the ego vehicle 2. In some embodiments, additional sensors may not be directly connected to the ego vehicle 2, but rather, may be located on a different entity, such as a drone or a stationary landmark such as a traffic light.

The ego vehicle 2 may operate under different levels of autonomy, such as any of Society of Automotive Engineers (SAE) levels between L1 and L5. In some embodiments, the ego vehicle 2 may operate under a level of autonomy, such as L1 or L2, that includes or supports Vehicle-to-Everything (V2X) or Vehicle-to-Vehicle (V2V) communication functionality, and/or other functionalities such as ADAS functionality.

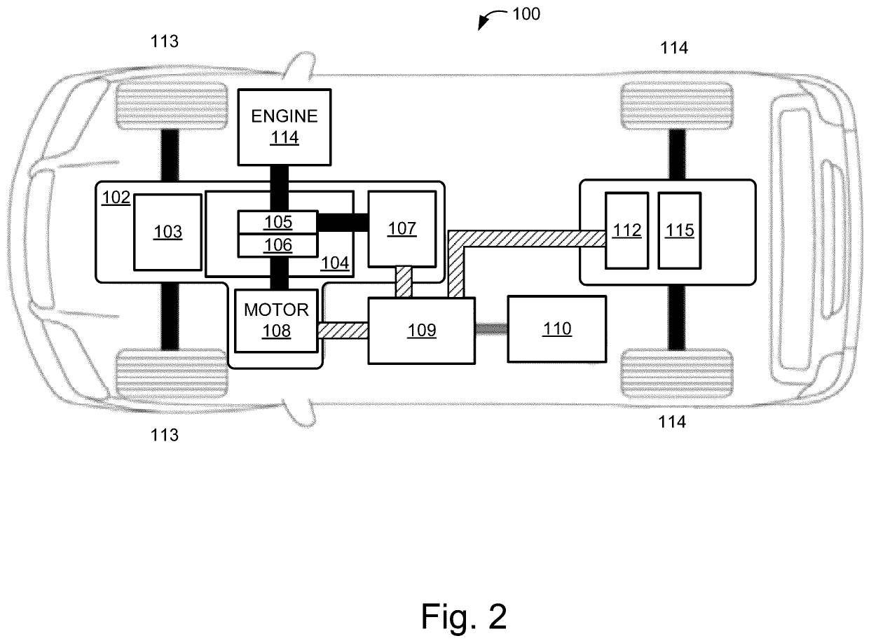

FIG. 2 is another example of an ego vehicle with which systems and methods for assessing occupant fitness can be implemented. The example illustrated in FIG. 2 is also that of a hybrid vehicle drive system of a vehicle 100 that may also include an engine 114 (e.g., internal combustion engine 14) and one or more electric motors 108, 112 (e.g., motors 22) as sources of motive power. In this example, a hybrid transaxle assembly 102 includes front differential 103, a compound gear unit 104, a motor 108, and a generator 107. Compound gear unit 104 includes a power split planetary gear unit 105 and a motor speed reduction planetary gear unit 106. This example vehicle also includes front and rear drive motors 108, 112, an inverter with converter assembly 109, battery 110 (which may include multiple batteries), and a rear differential 115. Hybrid transaxle assembly 102 enables power from engine 101, motor 108, or both to be applied to front wheels 113 via front differential 103.

Inverter with converter assembly 109 inverts DC power from battery 110 to create AC power to drive AC motors 108, 112. In embodiments where motors 108, 112 are DC motors, no inverter is required. Inverter with converter assembly 109 also accepts power from generator 107 (e.g., during engine charging) and uses this power to charge battery 110.

The examples of FIGS. 1 and 2 are provided for illustration purposes only as examples of vehicle systems with which embodiments of the disclosed technology may be implemented. An ego vehicle may include all or a portion of the components illustrated in FIG. 1 or 2. Other variations of vehicles, such as gasoline powered vehicles, may also be implemented. Any vehicles may be implemented with vehicle platforms.

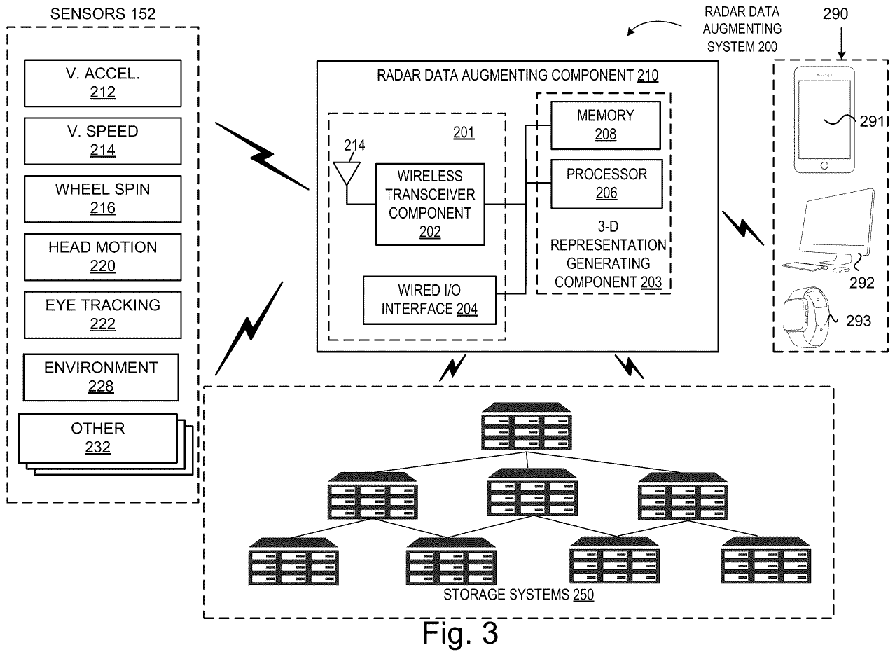

FIG. 3 illustrates an example architecture of a radar data augmenting system 200 for adaptively and selectively augmenting obstacle data of an obstacle, such as first obstacle data (e.g., radar data) captured by one or more first sensor systems (e.g., radar). In some embodiments, the obstacle may include any object, entity, or event that will, or has at least a threshold probability to impact navigation, and/or is located within a threshold distance of the ego vehicle. In some embodiments, the obstacle may include another vehicle (e.g., a lead vehicle in front of the ego vehicle 2, to a side of the ego vehicle 2, within a potential blind spot of the ego vehicle 2, or behind the ego vehicle 2). In some embodiments, the other vehicle may include a car, a truck, a bus, an authority vehicle, a motorcycle, any motor vehicle, and/or a bicycle. In some embodiments, the obstacle may include a pedestrian, a non-human organism, and/or a non-living or stationary object such as a landmark or a structure, to name some non-limiting examples.

In some embodiments, the first obstacle data may include raw data which may be processed into a first representation of the first obstacle data. In some embodiments, the first representation may be generated or obtained by filtering, converting (e.g., analog to digital conversion or vice versa), amplifying, smoothing, compressing, reformatting, transforming, merging, resolving, and/or otherwise processing the first obstacle data or other raw data from the one or more first sensor systems.

Augmenting of the first obstacle data may encompass enriching the first obstacle data with additional 3-D characteristics of the obstacle, which were previously absent from the first obstacle data. The additional 3-D characteristics may be generated or obtained from second obstacle data captured by one or more second sensor systems (e.g., vision sensors such as cameras) having a different modality of sensor compared to the first sensor systems.

Radar data augmenting system 200 may include a computer system or database system, and may further include a 3-D representation generating component 203. The 3-D representation generating component 203 may obtain the second obstacle data and selectively generate a second representation of the obstacle from the second obstacle data. In some embodiments, the second obstacle data may include monocular images. In some embodiments, the second obstacle data may include frames, portions, and/or other representations (hereinafter “frames”) of 2-D data of the obstacle. In some embodiments, the 3-D representation generating component 203 may generate the second representation by transforming the frames of 2-D data into a 3-D representation, which includes 3-D information of the second obstacle. In some embodiments, the 3-D representation may include a projection onto a 2-D space but include or otherwise indicate 3-D information of the second obstacle. The transforming of the frames of 2-D data into a 3-D representation may include techniques such as Neural Radiance Field (NeRF), Gaussian Splatting, and novel view synthesis methods, and/or similar or related techniques.

In some embodiments, as previously alluded to, the 3-D representation generating component 203 may selectively generate the second representation. If an updated version of the second representation has previously been generated and/or an updated version of the second representation has otherwise been learned by the 3-D representation generating component 203, the 3-D representation generating component 203 may refrain from generating the second representation and simply obtain the existing second representation. In order to determine whether a version of the second representation is updated, the 3-D representation generating component 203 may compare one or more characteristics of most recent obtained second obstacle data with a most recent version of the second representation. In some embodiments, the one or more characteristics may include any appropriate characteristics such as a pose and/or any 3-D features associated with the most recent obtained second obstacle data. In some embodiments, the 3-D representation generating component 203 may infer the one or more characteristics from the most recent obtained second obstacle data. In this manner, the 3-D representation generating component 203 may conserve computing and/or other onboard resources by avoiding the continuous or constant generating of the second representation and/or fusing of the second representation with the first representation.

Radar data augmenting component 210 may further include an radar data augmenting component 210, which obtains the first obstacle data and/or the first representation, the second obstacle data and/or the second representation, and augments the first representation with the second representation. In some embodiments, the radar data augmenting component 210 performs scan matching. Scan matching may include determining a transformation (e.g., translation and/or rotation) and/or a scaling difference between the second representation and the first representation, or a transformation and/or scaling difference between a second point or a second portion of the second representation relative to a corresponding first point or a first portion of the first representation. In some embodiments, the scan matching may include applying a transformation and a scaling operation onto the second representation to adjust or cancel out the transformation and scaling difference so that resulting transformation and scaling differences are less than respective threshold amounts. In some embodiments, the scan matching may include an iterative operation that continues until convergence and/or until resulting transformation and scaling differences are less than respective threshold amounts.

In some embodiments, the augmenting may occur following the scan matching. The augmenting may include merging, overlaying, synchronizing, fusing, smoothing, and/or otherwise combining and/or otherwise combining certain features of the second representation onto the first representation. As a result of the augmenting, a more accurate 3-D representation of the obstacle may be generated, as manifested by an augmented representation, which provides more accurate characterization of the obstacle and reliable distance estimates between the ego vehicle 2 and the obstacle, and/or between the obstacle and other obstacles. For example, using the augmented representation, the radar data augmenting component 210, or the radar data augmenting system 200, may determine or obtain a resolved distance between the ego vehicle 2 and the obstacle, which may be different from a distance obtained using the first representation from the radar without augmentation. These improvements provide more reliable data for navigation of the ego vehicle 2, thereby enhancing safety of the ego vehicle 2 and of surrounding traffic.

Furthermore, the augmenting may be performed without roll, pitch, or yaw rotation data of the ego vehicle 2. Such rotation data may be automatically discarded by filter systems of the ego vehicle, such as multi-object tracking Kalman filter systems.

In some embodiments, any or a portion of the aforementioned techniques or operations may be performed by the 3-D representation generating component 203, the radar data augmenting component 210, and/or by the radar data augmenting system 200, which may be onboard or otherwise associated with the ego vehicle 2. In some embodiments, any or a portion of the aforementioned techniques or operations may be performed using one or more external systems such as external database systems, an external cloud system and/or edge system. One or more results generated or obtained by the one or more external systems may be transmitted to any of the 3-D representation generating component 203, the radar data augmenting component 210, and/or by the radar data augmenting system 200.

Using the augmented representation, the radar data augmenting component 210, or a different component of the radar data augmenting system 200 may infer or determine one or more parameters or other characteristics of the obstacle from the augmented representation. In some embodiments, the one or more parameters or other characteristics (hereinafter “parameters”) may include one or more navigation characteristics of the obstacle. In some embodiments, navigation characteristics may include any of a position, a velocity, an acceleration, and/or a heading. Any of the navigation characteristics may be measured in absolute or relative terms with respect to the ego vehicle 2, and/or other obstacles. In some embodiments, the one or more parameters may include a distance (e.g., a minimum distance or a resolved distance) between the ego vehicle 2 and the obstacle, at one or more times, taking into account the 3-D geometry of the obstacle. In some embodiments, the one or more parameters may include 3-D geometry characteristics of the obstacle.

Using the one or more parameters, the radar data augmenting component 210, or a different component of the radar data augmenting system 200 may perform one or more navigation actions on the ego vehicle 2. The performing of one or more navigation actions, in some embodiments, may include controlling, programming, causing, and/or implementing one or more navigation actions of the ego vehicle 2. The one or more navigation actions may set or change a navigation characteristic of the ego vehicle 2 (e.g., an ego vehicle navigation characteristic).

For example, if the ego vehicle 2 is programmed to maintain a certain threshold distance or range of threshold distances from the obstacle, if the resolved distance determined using the augmented representation changes, then the ego vehicle 2 may adjust a navigation characteristic to maintain the distance.

As another example, the ego vehicle 2 may be programmed to change its threshold distance or range of threshold distances based on a degree of historical stability or instability of the obstacle (e.g., a frequency and/or a degree of change in one or more 3-D geometry characteristics of the obstacle). For example, certain obstacles may have portions that change a state, which alters a 3-D geometry of, or associated with, the obstacle and affects the determination of minimum distance. In one example, trailer doors of a truck may swing open frequently, which requires extra caution and following distance for nearby vehicles. In another example, a vehicle may deploy snow chains.

In some embodiments, based on a degree of instability of the obstacle, the ego vehicle 2 may navigate within a certain velocity range and/or acceleration range with respect to the obstacle range. For instance, assume for the sake of illustration that the ego vehicle 2 was previously programmed to always be moving at a velocity that is within 2 miles per hour of the velocity of the obstacle. Due to instability of the obstacle, the ego vehicle 2 may navigate at a speed that is at least 5 miles per hour slower than the obstacle.

In other examples, the radar data augmenting component 210, or a different component of the radar data augmenting system 200 may impose speed limits of the ego vehicle 2, and/or other navigation limits such as a turning radius limit, a turning limit for a steering wheel, and/or force limits on actuators such as brakes, which were previously not imposed, based on the one or more parameters of the obstacle, and/or based on a concentration or density of obstacles. In other examples, the radar data augmenting component 210 may selectively program the ego vehicle 2 to pull over, stop, or shut down depending on the parameters of the obstacle.

The radar data augmenting system 200, the radar data augmenting component 210, and/or the 3-D representation generating component 203, can be implemented as an ECU or as part of an ECU such as, for example electronic control unit 50. In other embodiments, the radar data augmenting system 200, the radar data augmenting component 210, and/or the 3-D representation generating component 203 can be implemented independently of the ECU. The radar data augmenting component 210 in this example includes a communication component 201, and the 3-D representation generating component 203 (including a processor 206 and memory 208 in this example). Components of the radar data augmenting component 210 are illustrated as communicating with each other via a data bus, although other communication in interfaces can be included.

The radar data augmenting system 200 may include a plurality of sensors 152, one or more storage systems 250 which may include servers within or associated within the ego vehicle 2, and one or more other devices 290 which may be external to or internally located within the ego vehicle 2. The one or more storage systems 250 may store any of the previously aforementioned data including, but not limited to, any current or historical first obstacle data, any current or historical first representations, any current or historical second obstacle data, any current or historical second representation, any current or historical parameters of the obstacle, and/or records of one or more navigation actions of the ego vehicle 2.

In some embodiments, the one or more other devices 290 include one or more different computing or mobiles devices 291, 292, and/or 293, and may be configured to receive a subset (e.g., a portion or all of) outputs from the radar data augmenting component 210, and/or the 3-D representation generating component 203, either in real-time or in a delayed manner via V2N communication.

Sensors 152, storage systems 250, and one or more other devices 290 can communicate with the radar data augmenting component 210 via a wired or wireless communication interface. Although sensors 152, storage systems 250 and one or more other devices 290 are depicted as communicating with the radar data augmenting component 210, they can also communicate with each other as well as with other vehicle systems.

Returning to the radar data augmenting system 200, the sensors 152 can include, for example, sensors 52 such as those described above with reference to the example of FIG. 1. Sensors 152 can include additional sensors. In the illustrated example, sensors 152 may include state detecting sensors which detect changes in state or status of an obstacle, such as closing and/or opening of a truck bed, and/or one or more objects at least partially falling out of a truck bed. These changes in state may trigger generating of a second representation and augmenting of the first representation to update a determination of resolved distance between the ego vehicle 2 and the obstacle.

The sensors 152 may include vehicle acceleration sensors 212, vehicle speed sensors 214, wheelspin sensors 216 (e.g., one for each road wheel), head motion sensors 220 to detect rotational and/or translational motion of a head of a driver within the ego vehicle 2, eye tracking sensors 222 to detect eye movements of the driver, and environmental sensors 228 (e.g., to detect traffic density, speed of surrounding traffic, weather, air quality, and/or other environmental conditions). In some embodiments, sensor data from the environmental sensors 228 may affect an action to be determined by the radar data augmenting system 200.

For example, if traffic density is high and/or the environment has hazy conditions, then the 3-D representation generating component 203 may be triggered to generate a second representation of the obstacle, and/or be triggered to generate, at a higher frequency, second representations of the obstacle, compared to a situation in which traffic density is low and/or the environment has clear conditions. Thus, the selective generation of a second representation may be based on the sensor data, such as a degree of traffic density, a traffic pattern, historical traffic data such as historical traffic patterns, and/or weather conditions such as a degree of haze or visibility.

Additional sensors 232 can also be included as may be appropriate for a given implementation of radar data augmenting system 200. The sensors 152 may be configured to detect and/or alert for any indications of anomalous behavior of any obstacles.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store any information used to detect potential interfering obstacles or generate visual representations, for processor 206 as well as any other suitable information. Memory 208 can be made up of one or more modules of one or more different types of memory, and may be configured to store data and other information as well as operational instructions that may be used by the processor 206.

Although the example of FIG. 3 is illustrated using processor and memory components, as described below with reference to components disclosed herein, the radar data augmenting system 200, including the radar data augmenting component 210 and/or the 3-D representation generating component 203, can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up the radar data augmenting system 200, the radar data augmenting component 210 and/or the 3-D representation generating component 203.

Communication component 201 includes either or both a wireless transceiver component 202 with an associated antenna 205 and a wired I/O interface 204 with an associated hardwired data port (not illustrated). As this example illustrates, communications with the radar data augmenting component 210 can include either or both wired and wireless communication components 201. Wireless transceiver component 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver component 202 and is used by wireless transceiver component 202 to transmit radio signals wirelessly to wireless equipment with which it is connected and to receive radio signals as well. These RF signals can include information of almost any sort that is sent or received by the radar data augmenting component 210 to/from other entities such as sensors 152 and storage systems 250.

Wired I/O interface 204 can include a transmitter and a receiver (not shown) for hardwired communications with other devices. For example, wired I/O interface 204 can provide a hardwired interface to other components, including sensors 152 and storage systems 250. Wired I/O interface 204 can communicate with other devices using Ethernet or any of a number of other wired communication protocols whether standardized, proprietary, open, point-to-point, networked or otherwise.

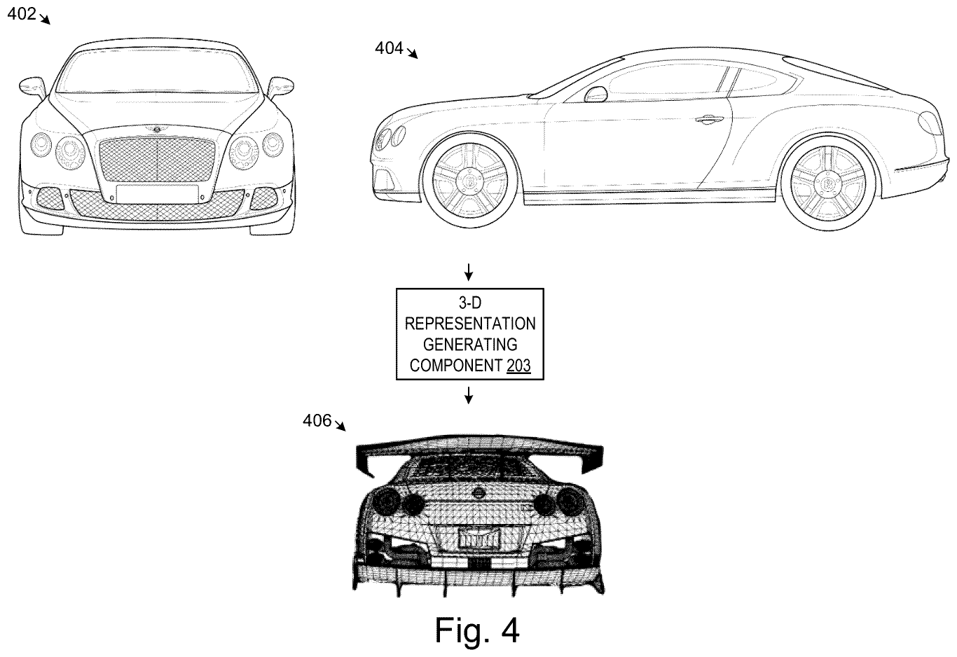

FIG. 4 illustrates an example implementation of the 3-D representation generating component 203. In some embodiments, the 3-D representation generating component 203 obtains second obstacle data 402, 404. The second obstacle data 402, 404 may include multiple frames of camera data from one or more different perspectives that captures an obstacle. In some embodiments, the second obstacle data 402, 404 may include raw sensor data of the obstacle captured by the one or more second sensor systems. In some embodiments, the second obstacle data 402, 404 may include processed data that has undergone operations such as filtering, converting (e.g., analog to digital conversion or vice versa), amplifying, smoothing, compressing, and/or otherwise transforming raw sensor data.

The 3-D representation generating component 203 may, from the second obstacle data 402, 404, selectively generate a second representation 406 of the obstacle. That is, the generating of the second representation may be under an assumption that no existing second representation corresponding to the obstacle is stored within the 3-D representation generating component 203 or elsewhere within the radar data augmenting system 200. In some embodiments, the assumption may, additionally or alternatively, include the 3-D representation generating component 203 not having learned one or more characteristics or parameters of the obstacle, such as a 3-D geometric characteristic of the obstacle, from the second representation 406.

In some embodiments, the second representation 406 may include a mesh representation. After generating the second representation 406, the 3-D representation generating component 203, or a different component within the radar data augmenting system 200, may learn a 3-D geometric characteristic, such as a 3-D geometric shape, of the obstacle based on the second representation 406. In some embodiments, learning may include acquiring or obtaining the one or more characteristics or parameters of the obstacle. In some embodiments, even after the second representation 406 has been generated, the 3-D representation generating component 203 may, continuously or at certain timing intervals, determine whether the second representation 406 should be updated. The 3-D representation generating component 203 may compare captured second obstacle data 402, 404 to the already generated second representation 406. If certain features or states from the second obstacle data 402, 404 do not match, or deviate by more than a threshold amount, from the generated second representation, then the constructing component may determine to update the second representation. For example, the second representation 406 may have a pose, state, or other features that do not match a corresponding pose or other features of the second obstacle data 402, 404. One example of such a mismatch is that the second representation illustrates or depicts an open bed whereas the second obstacle data 402, 404 illustrates a closed bed. Yet another example of such a mismatch is that the second representation has a presence or absence of snow chains, other appendages, or extensions which fails to match the second obstacle data 402, 404. Thus, a mismatch or deviation by more than a threshold amount between the most recently captured obstacle data 402, 404 and the already generated second representation 406 may trigger the 3-D representation generating component 203 to generate a new second representation 406 or update the existing second representation 406. In some embodiments, other triggers that may cause the generation of the second representation 406 may include a change in a navigation characteristic of the obstacle, such as a lane change, and one or more environmental conditions such as a change in a weather condition and/or a visibility condition, such as smog or air quality decrease. In some embodiments, the generation of the second representation 406 may occur at given time intervals.

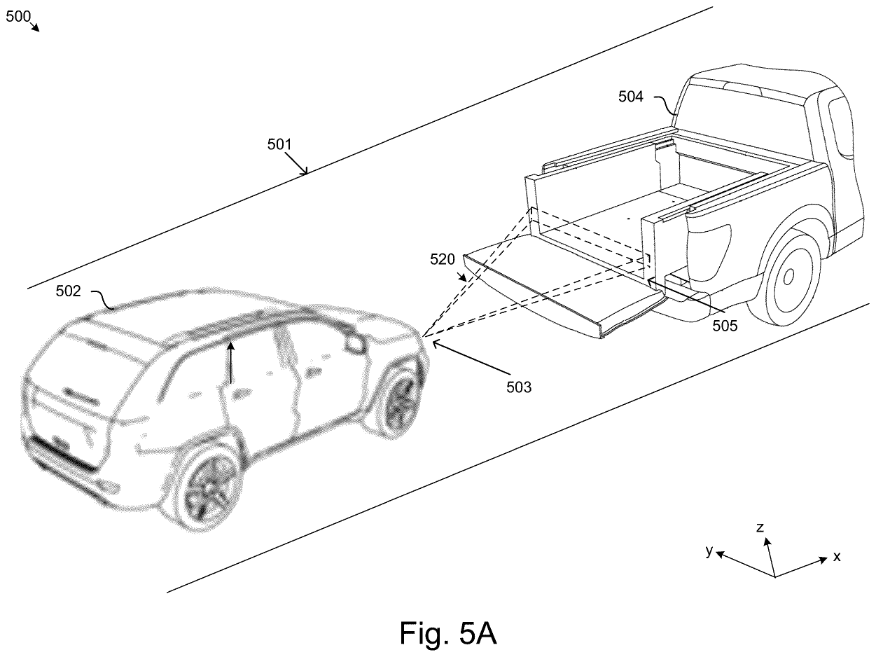

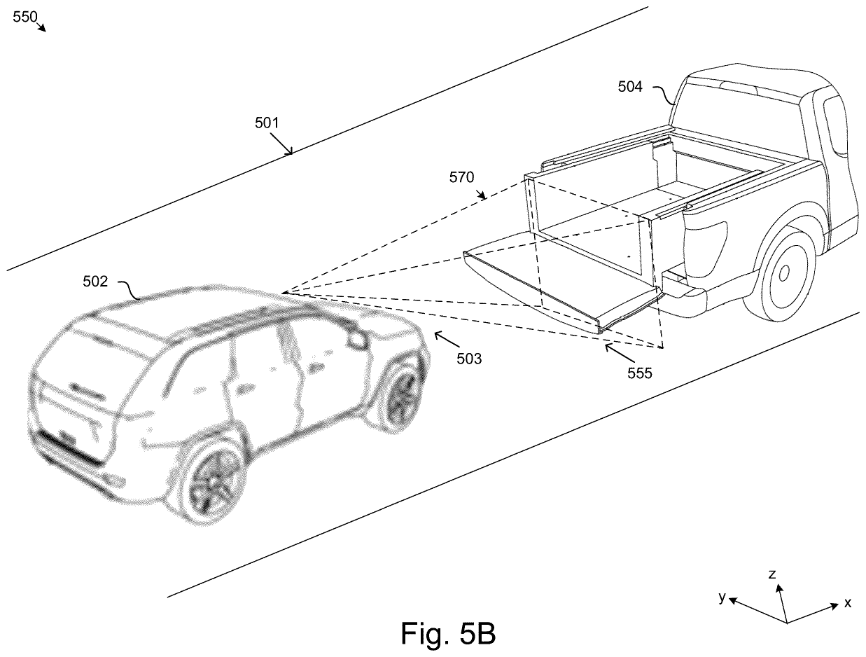

FIGS. 5A and 5B illustrate scenarios 500 and 550, to emphasize that augmenting of the aligned second representation with the first representation improves accuracy of distance determination and thereby improves reliability and safety of navigation actions, in ADAS-related contexts such as ACC. FIG. 5A illustrates the scenario 500, which includes a road 501, an ego vehicle 502, and an obstacle 504. In the scenario 500, the ego vehicle 502, which may be implemented as the ego vehicle 2, and the obstacle 504 may be travelling predominantly in a x-direction. A z-direction may be normal to a plane of the road 501 and may measure different heights. A y-direction may be perpendicular to a predominant direction of travel and along a plane of the road 501. The ego vehicle 502 may use first obstacle data and/or a first representation of the obstacle 504 to estimate a distance between the ego vehicle 502 and the obstacle 504, without using second obstacle data and/or a second representation of the obstacle 504. The first obstacle data may have been captured by one or more first sensor systems, which may include a radar sensor. Because radar may have a limited field of view 520, radar may scan predominantly along x-y planes. Radar may have limitations of scanning across different heights (e.g., different z-values). Thus, radar may fail to capture certain 3-D geometric features such as an open bed of a truck. Thus, using radar without camera data to augment, the ego vehicle 502 may mistakenly estimate or determine a distance between the ego vehicle 502 and the obstacle 504, as between a front 503 of the ego vehicle and a back 505 of the obstacle 504, not including an open bed. This is because the radar may fail to accurately capture or characterize an open bed.

Meanwhile, FIG. 5B illustrates how an augmented representation improves accuracy of detecting distances between the ego vehicle 502 and the obstacle 504. In the scenario 550, the ego vehicle 502 uses an augmented representation, in which the first representation is augmented by the second obstacle data and/or the second representation of the obstacle 504, in order to provide a more accurate 3-D representation of the obstacle 504. The second representation may include frames that are captured by one or more vision sensors such as a camera, which may have a field of view 570 that scans along additional vertical (e.g., z-direction) planes, segments, or regions. This results in a more accurate determination or estimate of a resolved distance between the ego vehicle 502 and the obstacle 504, as between the front 503 and an open bed 555.

Based on the determination of the distance 560, the ego vehicle 502 may perform one or more navigation actions, such as increasing a relative distance setpoint or time-to-collision parameter. These navigation actions may also apply in certain ADAS settings, such as ACC or blind spot detection.

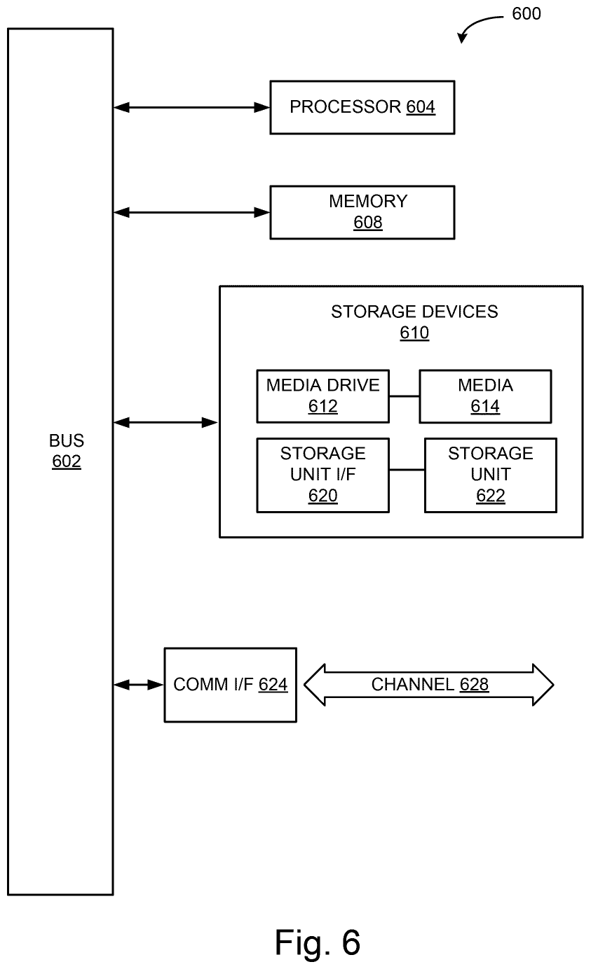

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example-computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. This can include a processor, and/or any one or more of the components. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Reference to A “and” B may be construed to also encompass the scenario of A “or” B. Reference to A “or” B may be construed to also encompass the scenario of A “and” B. Any reference to a “threshold” or “sufficiency” may be construed to encompass any applicable value or degree, such as any applicable value or degree sufficient to satisfy a given outcome. In some examples, a threshold level, similarity or degree thereof may be construed to include any values such as 99 percent, 98 percent, 95 percent, 90 percent, 80 percent, 75 percent, or any other value therebetween, or any ranges therebetween. Additionally or alternatively, a threshold similarity or degree may be construed as qualitatively satisfying some condition, such as presence of one or more common features. Any reference to sufficiently similar may also be construed to encompass same or similar meanings as satisfying a threshold. Reference to “likely,” “a likelihood,” or “probable” or any variation thereof may be construed as satisfying some threshold likelihood or probability.

In some embodiments, a threshold distance may refer to any distance in which an obstacle may have at least a threshold likelihood or probability of affecting one or more navigation actions or characteristics of the ego vehicle. In some embodiments, a threshold distance may refer to an acceptable following distance or maintaining distance according to one or more standards. For example, a threshold distance may include any distances equivalent to, or less than, 3 seconds, 10 seconds, or 20 seconds of travel at a current speed, and/or any subranges therein.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system associated with an ego vehicle, the system comprising:
one or more first sensor systems configured to obtain first obstacle data of an obstacle within a threshold distance of an ego vehicle, wherein the one or more first sensor systems comprise a radar sensor; and
one or more second sensor systems configured to obtain second obstacle data of the obstacle, wherein the one or more second sensor systems comprise a camera;
one or more processors;
a memory storing instructions that, when executed by the one or more processors, cause the system to perform:
generating, based on the first obstacle data, a first representation of the obstacle;
selectively applying one or more construction techniques to the second obstacle data to generate a second representation of the obstacle;
aligning the second representation with the first representation; and
augmenting the first representation with the aligned second representation to generate an augmented representation of the obstacle.

2. The system of claim 1, wherein the second representation of the obstacle comprises a three-dimensional (3-D) representation, the second obstacle data comprises two-dimensional (2-D) data, and the selectively applying one or more construction techniques to the second obstacle data comprises transforming the 2-D data into the 3-D representation.

3. The system of claim 1, wherein the selectively applying one or more construction techniques to the second obstacle data is performed in response to one or more trigger conditions.

4. The system of claim 3, wherein the one or more trigger conditions comprise a navigation action of the ego vehicle or a deviation between a pose estimate and the second representation.

5. The system of claim 1, wherein the instructions that, when executed by the one or more processors, further cause the system to perform:
based on the augmenting representation, determining a resolved distance between the ego vehicle and the obstacle, wherein the resolved distance is different from a distance between the ego vehicle and the obstacle estimated based on the first representation; and
performing a navigation action on the ego vehicle based on the resolved distance.

6. The system of claim 5, wherein the navigation action on the ego vehicle comprises setting or changing a relative distance between the ego vehicle and the obstacle.

7. The system of claim 1, wherein the instructions that, when executed by the one or more processors, further cause the system to perform:
determining whether the second representation of the obstacle is known, wherein the selectively applying one or more construction techniques is in response to determining that a second representation of the obstacle is unavailable.

8. The system of claim 7, wherein the instructions that, when executed by the one or more processors, further cause the system to perform:
in response to determining that the second representation of the obstacle is known, terminating the one or more construction techniques.

9. The system of claim 1, wherein the one or more construction techniques comprise a Neural Radiance Field (NeRF), a Gaussian Splatting, or a view synthesis technique.

10. The system of claim 1, wherein the selectively aligning the second representation with the first representation is based on a translation, a rotation, or a scaling operation applied to the second representation based on a translation, a rotation, or a scaling offset between the first representation and the second representation.

11. A vehicle control system, comprising:
a processor; and
a memory coupled to the processor to store instructions, which when executed by the processor, cause the processor to perform operations, the operations comprising:
obtaining, from one or more first sensor systems, first obstacle data of an obstacle within a threshold distance of an ego vehicle,
generating, based on the first obstacle data, a first representation of the obstacle;
obtaining, from one or more second sensor systems, second obstacle data of the obstacle;
selectively applying one or more construction techniques to the second obstacle data to generate a second representation of the obstacle;
aligning the second representation with the first representation; and
augmenting the first representation with the aligned second representation to generate an augmented representation of the obstacle.

12. The vehicle control system of claim 11, wherein the second representation of the obstacle comprises a three-dimensional (3-D) representation, the second obstacle data comprises two-dimensional (2-D) data, and the applying one or more construction techniques to the second obstacle data comprises transforming the 2-D data into the 3-D representation.

13. The vehicle control system of claim 12, wherein the selectively applying one or more construction techniques to the second obstacle data is performed in response to one or more trigger conditions.

14. The vehicle control system of claim 13, wherein the one or more trigger conditions comprise a navigation action of the ego vehicle or a deviation between a pose estimate and the second representation.

15. The vehicle control system of claim 11, wherein the instructions, which when executed by the one or more processors, further cause the processor to perform:
based on the augmenting representation, determining a resolved distance between the ego vehicle and the obstacle, wherein the resolved distance is different from a distance between the ego vehicle and the obstacle estimated based on the first representation; and
performing a navigation action on the ego vehicle based on the resolved distance.

16. The vehicle control system of claim 15, wherein the navigation action on the ego vehicle comprises setting or changing a relative distance between the ego vehicle and the obstacle.

17. The vehicle control system of claim 11, wherein the instructions, which when executed by the one or more processors, further cause the processor to perform:
determining whether the second representation of the obstacle is known, wherein the applying one or more construction techniques is in response to determining that a second representation of the obstacle is unavailable.

18. The vehicle control system of claim 11, wherein the instructions, which when executed by the one or more processors, further cause the processor to perform:
in response to determining that the second representation of the obstacle is known, terminating the applying one or more construction techniques.

19. The vehicle control system of claim 18, wherein the one or more construction techniques comprise a Neural Radiance Field (NeRF), a Gaussian Splatting, or a view synthesis technique.

20. The vehicle control system of claim 11, wherein the aligning the second representation with the first representation is based on a translation, a rotation, or a scaling operation applied to the second representation based on a translation, a rotation, or a scaling offset between the first representation and the second representation.
